(19) United States
(12) Patent Application Publication
(10) Pub. No.: US 2008/0296966 A1
(43) Pub. Date: Dec. 4, 2008

(54) Bicycle of Shaking Equipment

(76) Inventor: In Sup Choi, Incheon (KR)

Correspondence Address: IPLA P.A., 3580 WILSHIRE BLVD., 17TH FLOOR, LOS ANGELES, CA, 90010, US

(21) Appl. No.: 12/089,824

(22) PCT Filed: Feb. 9, 2006
(86) PCT No.: PCT/KR06/00468

§ 371 Date: Apr. 10, 2008

(30) Foreign Application Priority Data
Oct. 10, 2005 (KR) 10-2005-0094727

(51) Int. Cl. B60B 27/00

(52) U.S. Cl. 301/110.5

(57) ABSTRACT

Disclosed is a bicycle of shaking equipment capable of carrying out a normal rotation running or a shaking rotation running according to the rotation of a hub. The bicycle of shaking equipment has an adjusting means causing a cylindrical eccentric cam inserted and installed a hub and the inside of the hub to make a centrifugal rotation and an eccentric rotation to be carried out, wherein the adjusting means may be used as a handle lever installed to the handle. And a wire cable of a handle lever makes a rotation piece to be rotated on basis of a pin. A connection long rod inserted and coupled in a guide tube portion of a hub screw axis makes a movable member inserted in a guide part of the center of the hub screw axis to be moved back and also moved forward by the elasticity of a coil spring of the hub screw axis to restore, and due to this key pin elastically installed the hub and the inside of pin hole of the cylindrical eccentric cam makes the hub and the cylindrical eccentric cam to be incorporated. By the normal rotation running of the rear wheel for a bicycle and the shaking rotation running, it is easy for any one to carry out the manipulation of the athletic running for diet besides a general running.

### TECHNICAL FIELD

The present invention relates to a bicycle of shaking equipment, and in particular to a bicycle of shaking equipment capable of easily performing the manipulation of a normal rotation running and a shaking rotation running by a hand lever coupled to a bicycle handle, simultaneously with running on a bicycle in a bicycle of shaking equipment for carrying out a normal rotation running and a shaking rotation running according to the rotation of a hub and an eccentricity rotation or a shaking rotation at a rear wheel of a bicycle so as to be able to manipulate suitably for a physical diet exercise, resulting in being conveniently used by such construction.

### BACKGROUND ART

In a conventional bicycle of shaking equipment, an eccentric cam is made to be fixed on the both side of a hub axis at the rear wheel of the bicycle and an eccentric cam insertion groove and a movement space is formed on the side face of hub coupled to both hub and thereby, the eccentric cam is inserted and installed into the eccentric cam insertion groove and on the upper of the eccentric cam and the side face of the hub is formed a screw insertion hole and a screw hole and then screw-engaged with an adjusting bolt or a connection screw. Also, disclosure of Korean Utility registration publication No. 0384083 is directed to a shaking equipment of a bicycle wheel, in which the manipulation of the adjusting bolt can make the eccentric cam of the hub axis to be positioned at the movement space.

This is a structure that the moving manipulation of the eccentric cam fixed on the both side of the hub axis may be carried out in hand by the adjustment of the adjusting bolt and therefore the bicycle may be made to be taken off every when a normal rotation running for a normal running of the bicycle and a shaking rotation running for athletics are carried and engagement or disengagement of the adjusting bolt may be carried out with a tool in hand. It is inconvenient to carry out on manipulation, as well as using an instrument such as a tool. Specially, it is difficult to use such instrument to who has a poor manipulation about a tool, women, boys, and girls.

### DISCLOSURE

### Technical Problem

The present invention is designed in consideration of the above problems, and therefore it is an object of the invention to provide a bicycle of shaking equipment capable of changing a normal rotation and a shaking rotation at a rear wheel, in which the manipulation of a normal rotation running and a shaking rotation running may be easily performed to anyone by a hand lever coupled to a bicycle handle during running.

### Technical Solution

In order to accomplish the above object, the present invention provides a bicycle of shaking equipment capable of inserting and installing a cylindrical eccentric cam having the formation of an internal space part which is made with the penetration and formation of a cam insertion groove at an eccentric position on a hub side face of a bicycle wheel, of carrying out the engagement and fixation of an engagement screw to be inserted into and engaged with a hub screw by forming an eccentric screw hole on the both side wall of the space part, of carrying out the exterior exposure of an engagement screw which is inserted and penetrated through the both of a hub screw axis having a guide groove formed in a central guide part, of inserting a coil spring being elastically installed on one side of the hub screw axis, into a protuberance of a movable member achieved by formation of a low face and a high sphere face with a guide groove and being coupled so as to be moved in a left or right direction, of connecting an inner end to the protuberance with the long insertion of a connection long rod in one side guide tube part of a hub screw axis and connecting an outer end on a projection piece of a fixed end portion coverage to one end of a [symbol] -shaped rotation piece installed to be rotated by a pin, of connecting an inner end to the protuberance and an outer end to one end of a [symbol] -shaped rotation piece installed with being rotated with a pin 28 to a protuberance piece of a end cover fixed to the outer end of the hub screw axis, by at a long inserting a connection long rod within a guide tube part of one side of the hub screw axis, of inserting and installing the key pin 7 which installs a circle face at the lower end and a ball at the upper end with the spring by forming pin holes at the same position which penetrates through the center of the cylindrical eccentric cam and the hub, in the pin hole elastically acted by a coil spring at a space part and for contacting the circle face with the low face and the high sphere face of the movable member, and of engaging and installing a general chain gear with a projecting screw of the engagement screw.

### ADVANTAGEOUS EFFECTS

By using a bicycle of shaking equipment according to the present invention, it is possible to have a structure in which a cylindrical eccentric cam 5 with the formation of a cam insertion groove 4 at an eccentric position on the side face a hub 3 at a rear wheel 2 for a bicycle 1, is inserted and coupled and the engagement and fixation of engagement screws 15 and 15′ to be inserted into and engaged with a hub screw axis 14 by forming eccentric screw holes 13 and 13′ on the both side wall of a space part 11, is carried out wherein the engagement screw 15 is installed on a brake device 37 and a general chain gear 33 which is effective on running of the bicycle 1, is engaged and installed with a projecting screw 32, resulting in making the hub 3 to be eccentrically or normally rotated.

Further, it is possible to have a structure in which a [symbol] -shaped rotation piece 27 with the rotating manipulation of the hand lever 30 installed on the handle 29 of the bicycle 1, makes to be moved back a connection long rod 24 which is within a guide tube portion 23 of the hub screw axis 14 installed on the center of engagement screws 15 and 15′ and a movable member 20 is moved at a guide part 18 by the elastic restoration of a shrunken spring 22, resulting in being inserted into pin holes 10 and 10′ to be elastically acted with the coil spring 6 and so the eccentric rotation and normal rotation of the hub 3 are carried out by being inserted into pin holes 10 and 10′ with upward and downward movement of the key pin 7 due to the contact of the circle face 8 with the lower face 19 and the high sphere face 19′ of the movable member 20 and therefore it is possible for any one to inconveniently change during running of the bicycle 1 by the manipulating of the hand lever 30.

Accordingly, it is possible to easily manipulate the hand lever 30 for riding without taking off from the bicycle 1 during running because the shaking rotation is carried out with the up and down rotation of the rear wheel 2, resulting in carrying out the changing operation of a normal running and a athletic running for diet.

### DESCRIPTION OF DRAWINGS

FIG. 1 is a side view showing a bicycle of shaking equipment according to the present invention;

FIG. 2 is an enlarged view seen in a direction of A-A line of FIG. 1;

FIG. 3 is a cross-section view of FIG. 2;

FIG. 4 is a cross-section view showing an operational state of FIG. 2;

FIG. 5 is a cross-section view seen in a direction of B-B line of FIG. 3;

FIG. 6 is a cross-section view seen in a direction of C-C line of FIG. 4;

FIG. 7 is a side view showing one part of a movable member and a key pin according the present invention; and

FIG. 8 is a side view of a hub screw axis according the present invention.

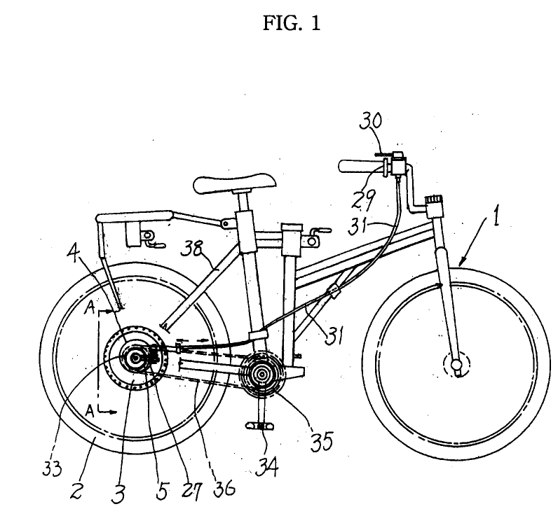

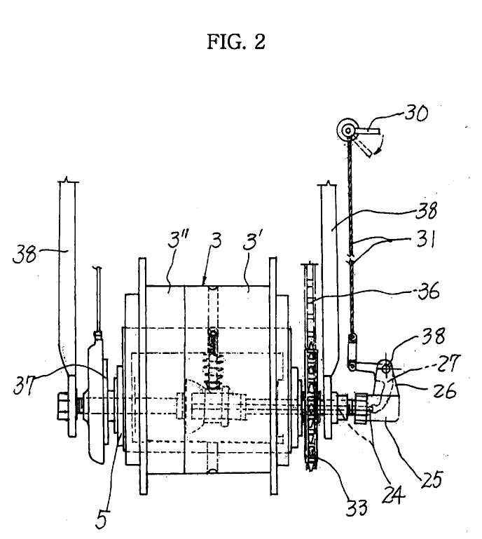

### BEST MODE

Hereinafter, a bicycle of shaking equipment according to the present invention will be described in detail referring to the accompanying drawings.

A bicycle of shaking equipment according to the present invention has two partitions divided from a hub 3 of a rear wheel 2 in a bicycle 1. A cylindrical eccentric cam 5 having an internal space part achieved by forming a cam insertion groove 4 penetrated from an eccentric position at the side face of the hub 3 is transversally inserted and installed in the cam insertion groove 4 to be able to be rotated, and at the same upper and lower position of the cylindrical eccentric cam 5 as that of the hub 3 pin holes 10 and 10′ are formed so that a key pin 7 acted on an elasticity of a coil spring 6 may be made to be inserted into the pin holes 10 and 10′ with the installation and insertion of key pin 7 in the pin hole 10′ at a space part 11. Also, the upper of the key pin has a circle face 8 and its lower key pin 7 and the cylindrical eccentric cam 5 makes an abrasion lower due to a ball 12 in case of rotation along the inner wall face of the cam insertion groove 4 by installing the ball 12 on its upper acted on an elasticity of the a lower spring 9.

Further, eccentric screw holes 13 and 13′ into which a hub screw axis 14 is inserted is formed the space part 11 of the cylindrical eccentric cam 5 and engagement screws 15 and 15′ are fixedly engaged with the eccentric screw holes 13 and 13′, and also the both ends of the hub screw axis 14 are inserted in the center portion of the engagement screws 15 and 15′ and projected to the exterior. At this time, a bearing 16 is inserted in the inside of the engagement screws 15 and 15′, and a movable member 20 achieved by a lower face and a high sphere face 19′ formed on an outer face of a guide part 18 having a long opened guide groove 17 at the center of the hub screw axis 14, is inserted and coupled to a guide groove 17. The left and right movement of the movable member 20 along a guide groove 17 of a guide part 18 is made to be possible. Simultaneously, a circle face 8 of a bottom end of key pin 7 is contacted with low face 19 of a movable member 20 and a high sphere face 19′. The coil spring 22 which is elasticity coupled to a movable member 20 again is installed on the one side of the hub screw axis 14 so that the inner end with the insertion of the connection long rod 24 into a guide tube portion 23 at the inside of the opposing is connected with the center of the protuberance 21 of a movable member 20, and the outer end is coupled and installed to the one side of a [symbol] -shaped rotation piece 27 so as to be rotated against a protuberance piece 26 of a end cover 25 and then a connection long rod 24 is made to be pushed by the rotation of the rotation piece 27 on basis of a pin 28. Therefore, the movable member 20 is moved back, simultaneously with the shrinking of the coil spring 22. The movable member 20 is moved forward by an elastic restoration force when the rotation piece 27 is rotated in a reverse direction, and the circle face of the key pin 7 which was positioned at the lower face 19 of the movable member 20 is positioned at the high sphere face 19″ of the movable member 20 and thereby moving up the key pin 7 and being rotated together with the hub 3 and the cylindrical eccentric cam 5 which is incorporated with each other.

Further, a wire cable 31 of the hand lever 30 installed on the handle 29 of the bicycle 1 is connected with the other side of the [symbol] -shaped rotation piece 27 and the rotation piece 27 is operated with the rotating manipulation of the hand lever 30.

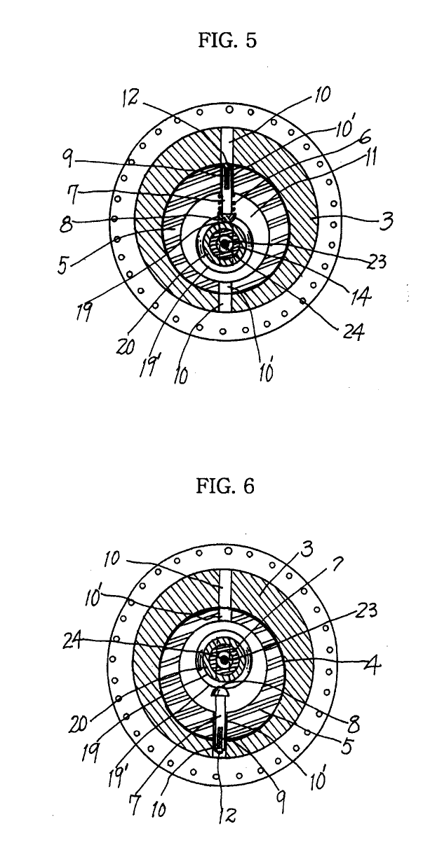

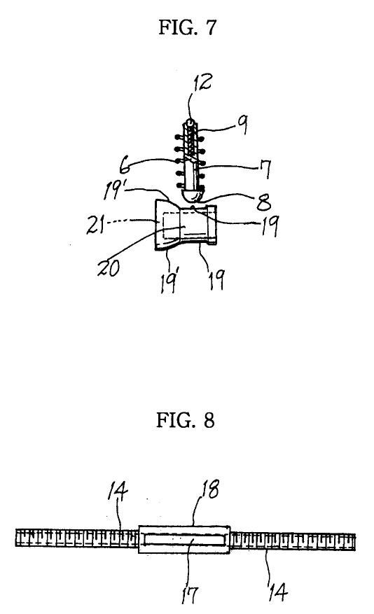

A chain gear 33 is engaged and fixed to a projecting screw 32 of the engagement screw 15′ and being kicked the pedal for the bicycle 1 connected and coupled to the engagement screws 15 and 15′ with the rotation of a normal pedal 34 because of coupling a chain 36 between a chain gear 35 and the pedal 34 for the bicycle 1, is as a rotation operation transferred to the hub 3 through the chain gear 33, engagement screw 15′, and the eccentric cam 5 and therefore the cylindrical eccentric cam 5 and the hub 3 is incorporated. The hub 3 is made to carry out an eccentric rotation when the key pin 7 installed on these pin holes 10 and 10′ is positioned at the same position of FIG. 5 and therefore the rear wheel 2 coupled to the hub 3 by a comb shaft (not shown) is shakily rotated within the rage of an eccentricity and in reverse the hub 3 is made to be eccentrically rotated when the key pin 7 is at the same position as that of FIG. 6 and therefore the rear wheel 2 is made to be rotated normally.

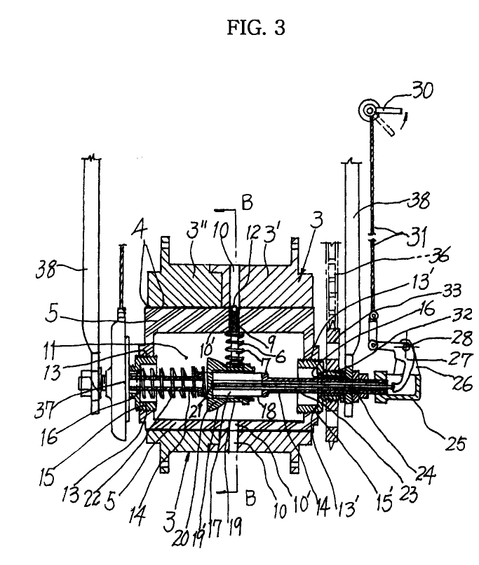

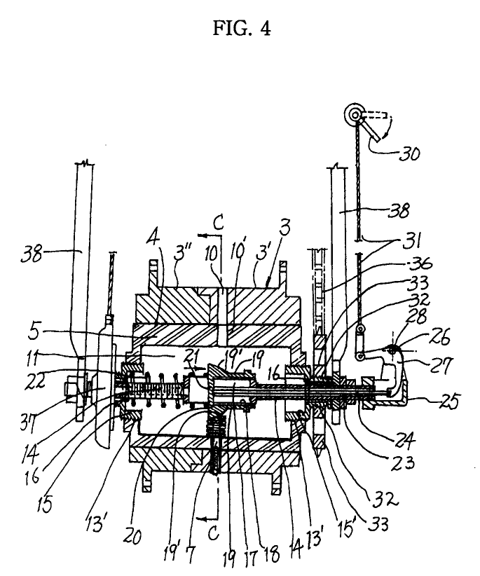

And, the operation that the key pin 7 is deeply or lowery inserted into the pin holes 10 and 10′ is carried out with the rotating manipulation of the hand lever 30 installed on the handle 29 for the bicycle 1 as shown in FIG. 3 and FIG. 4 and the [symbol] -shaped rotation piece 27 connected with a wire cable 31 is rotated left or right, simultaneously with being moved forward by pushing the connection long rod 24. The coil spring 22 is shrunk, simultaneously with moving the movable member 20 of the central portion of the hub screw axis 14.

At the same time, the ball 12 is rotated and inserted along the inner wall of the cam insertion groove 4 when the circle face 8 of the key pin 7 as shown in FIG. 3 is positioned at the lower face 19 of the movable member 20 and in reverse the [symbol] -shaped rotation piece 27 is also restored to an original state when the hand lever 30 which was rotated at the above is restored to an original state.

This is that the movable member 20 is moved by the elastic restoration force of the coil spring 22 elastically installed on one side of the hub screw axis 14 and therefore the cylindrical eccentric cam 5 and the hub 3 are rotated together because the circle face 8 of the key pin 7 is positioned at the high sphere face 19′ of the movable member 20. The cylindrical eccentric cam 5 is inserted and installed in the cam insertion groove 4 which is positioned at an eccentric position, so as to be rotated and also inserted and coupled in the pin holes 10 and 10′ with being rotated like the key pin 7. The key pin 7 is coupled and rotated to the cylindrical eccentric cam 5 and the hub 3, via the pin holes 10 and 10′ according to the rotation operation of the cylindrical eccentric cam 5 and the hub 3 according to the rotation operation of the chain gear 33, the back movement of the movable member 20 achieved by the manipulation of the hand lever 30, and the forward movement with the elastic restoration force after the shrinking of the coil spring 22.

1. A bicycle of shaking equipment comprises:
means for inserting and installing a cylindrical eccentric cam 5 having the formation of an internal space part 11 which is made with the penetration and formation of a cam insertion groove 4 at an eccentric position on the side face a hub 3 at a rear wheel 2 for a bicycle 1, and for carrying out the engagement and fixation of engagement screws 15 and 15′ to be inserted into and engaged with a hub screw axis 14 by forming eccentric screw holes 13 and 13′ on the both side wall of the space part 11;
means for carrying out the exterior exposure of the engagement screws 15 and 15′ which are inserted and penetrated through the both of the hub screw axis 14 having a guide groove 17 formed in a central guide part 18, and for inserting a coil spring 22 being elastically installed on one side of the hub screw axis 14, into a protuberance 21 within a movable member 20 achieved by the formation of a low face 19 and a high sphere face 19′ with the guide groove 17 and being coupled so as to be moved in a left or right direction; and
means for connecting an inner end to the protuberance 21 and an outer end to one end of a [symbol] -shaped rotation piece 27 installed capable of being rotated with a pin 28 to a protuberance piece 26 of a end cover 25 fixed to the outer end of the hub screw axis 14, by at a long inserting a connection long rod 24 within a guide tube part of one side of the hub screw axis 14;
means for inserting and installing the key pin 7 which installs a circle face 8 at the lower end and a ball 12 at the upper end with spring by forming pin holes 10 and 10′ at the same position which penetrates through the center of the cylindrical eccentric cam 5 and the hub 3, in the pin hole 10′ elastically acted by a coil spring 6 at a space part 11 and for contacting the circle face 8 with the low face 19 and the high sphere face 19′ of the movable member 20; and
means for engaging and installing a general chain gear 33 with a protuberance screw 32 of the engagement screw 15′.
